(19) United States
(12) Patent Application Publication
(10) Pub. No.: US 2014/0004875 A1
(43) Pub. Date: Jan. 2, 2014

(54) ASCERTAINING PRESENCE REGIONS FOR MOBILE TELEPHONY

(71) Applicants: Vikas Agarwal, New Delhi (IN); Sumit Mittal, New Delhi (IN); Venkatraman Ramakrishna, New Delhi (IN)

(72) Inventors: Vikas Agarwal, New Delhi (IN); Sumit Mittal, New Delhi (IN); Venkatraman Ramakrishna, New Delhi (IN)

(73) Assignee: INTERNATIONAL BUSINESS MACHINES CORPORATION, Armonk, NY (US)

(21) Appl. No.: 13/537,772

(22) Filed: Jun. 29, 2012

(51) Int. Cl. H04W 24/00

(52) U.S. Cl. 455/456.1

(57) ABSTRACT

Methods and arrangements for ascertaining mobile presence regions. Mobile telephony data are obtained for a user, and a location of the user is tracked for a plurality of timepoints. The tracking includes forming and populating a user presence table. With respect to incomplete information in the user presence table and based on data in the user presence table, a location of the user for at least one other timepoint is estimated.

### BACKGROUND

Location-based presence information of a mobile phone user can be very useful in a variety of scenarios. For instance, it can permit relevant promotions or ads to be sent to a user, while notifications or information in which a user has interest can be disseminated. A user can also be in a position to identify people belonging to his/her social networks who are in the same geographical region.

A user's location typically varies over time in a characteristic cyclical manner. For example, a user might be at his/her workplace during the day and at home during the evening. On the other hand, he/she may typically visit a mercantile establishment regularly, such as a particular restaurant most Saturday evenings

Generally, in the context of mobile telephony, presence information is not always available. Normally, it has been found that the infrastructure needed for a continuous collection and storage of location information for mobile phones is prohibitively expensive. Therefore, it is conventionally the case that only a current location is typically used or embraced by a wireless provider (or other entity) when such information is available.

This can permit some degree of location-based advertising and other location-based services, but it only is functional when a current location is available, e.g., via GPS or triangulation. An assessment of location is typically not made in contexts where location data are not directly or immediately determinable.

### BRIEF SUMMARY

In summary, one aspect of the invention provides a method comprising: obtaining mobile telephony data for a user; tracking a location of the user for a plurality of timepoints; the tracking comprising forming and populating a user presence table; and estimating, with respect to incomplete information in the user presence table and based on data in the user presence table, a location of the user for at least one other timepoint.

Another aspect of the invention provides an apparatus comprising: at least one processor; and a computer readable storage medium having computer readable program code embodied therewith and executable by the at least one processor, the computer readable program code comprising: computer readable program code configured to obtain mobile telephony data for a user; computer readable program code configured to track a location of the user for a plurality of timepoints, the tracking including forming and populating a user presence table; and computer readable program code configured to estimate, with respect to incomplete information in the user presence table and based on data in the user presence table, a location of the user for at least one other timepoint.

An additional aspect of the invention provides a computer program product comprising: a computer readable storage medium having computer readable program code embodied therewith, the computer readable program code comprising: computer readable program code configured to obtain mobile telephony data for a user; computer readable program code configured to track a location of the user for a plurality of timepoints, the tracking including forming and populating a user presence table; and computer readable program code configured to estimate, with respect to incomplete information in the user presence table and based on data in the user presence table, a location of the user for at least one other timepoint.

A further aspect of the invention provides a method comprising: obtaining mobile telephony data for a user from call data records; tracking locations of the user over a predetermined time period; the tracking comprising forming and populating a user presence table; and estimating, with respect to incomplete information in the user presence table and based on data in the user presence table, a location of the user with respect to at least one other time period.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 schematically illustrates a solution overview.

FIG. 2 sets forth an example of a presence table.

FIG. 3 sets forth an example of a group presence table.

FIG. 4 sets forth a process more generally for ascertaining mobile presence regions.

FIG. 5 illustrates a computer system.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art may well recognize, however, that embodiments of the invention can be practiced without at least one of the specific details thereof, or can be practiced with other methods, components, materials, et cetera. In other instances, well-known structures, materials, or operations are not shown or described in detail to avoid obscuring aspects of the invention.

The description now turns to the figures. The illustrated embodiments of the invention will be best understood by reference to the figures. The following description is intended only by way of example and simply illustrates certain selected exemplary embodiments of the invention as claimed herein.

It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

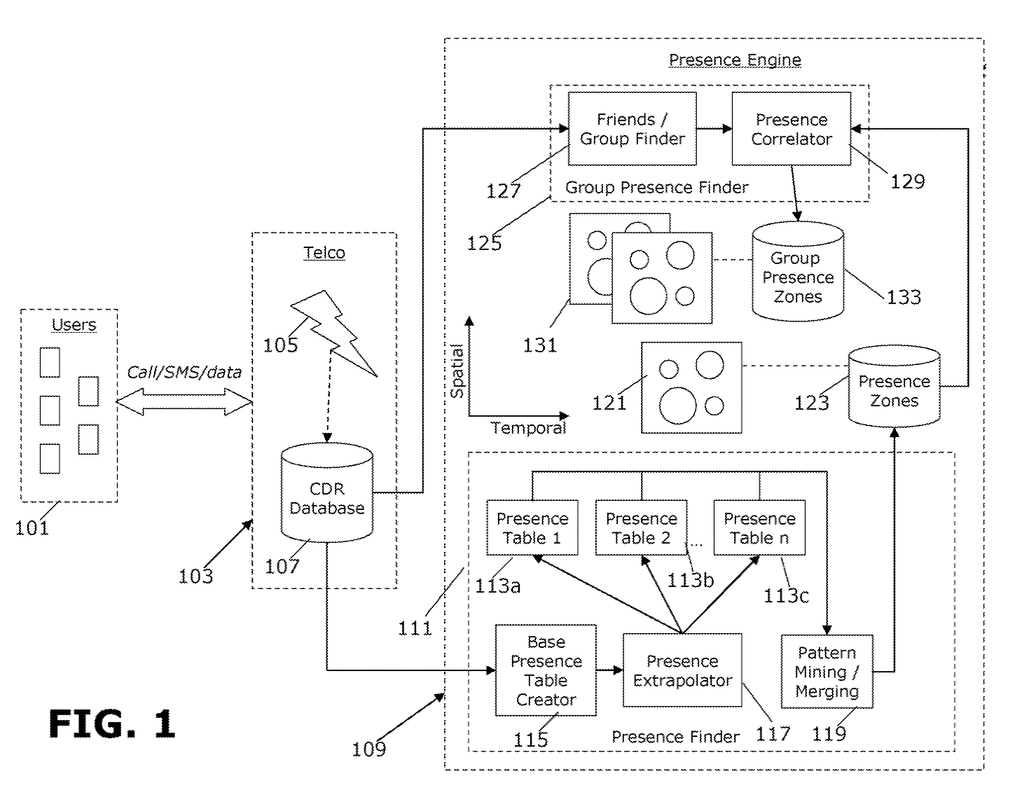

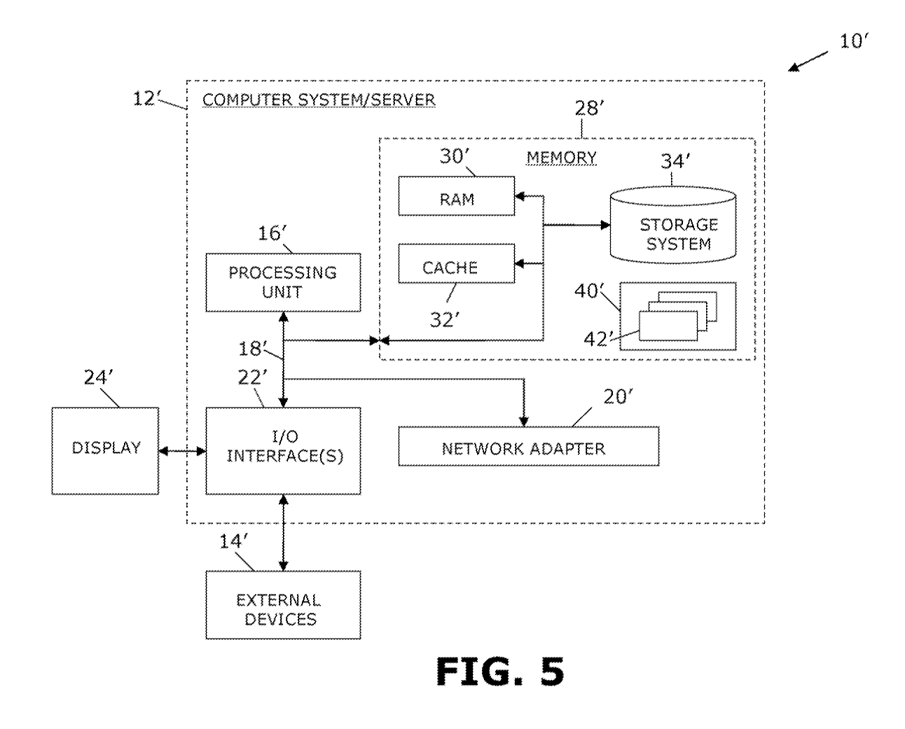

Specific reference will now be made herebelow to FIGS. 1-3. It should be appreciated that the processes, arrangements and products broadly illustrated therein can be carried out on, or in accordance with, essentially any suitable computer system or set of computer systems, which may, by way of an illustrative and non-restrictive example, include a system or server such as that indicated at 12′ in FIG. 5. In accordance with an example embodiment, most if not all of the process steps, components and outputs discussed with respect to FIGS. 1-3 can be performed or utilized by way of a processing unit or units and system memory such as those indicated, respectively, at 16′ and 28′ in FIG. 5, whether on a server computer, a client computer, a node computer in a distributed network, or any combination thereof.

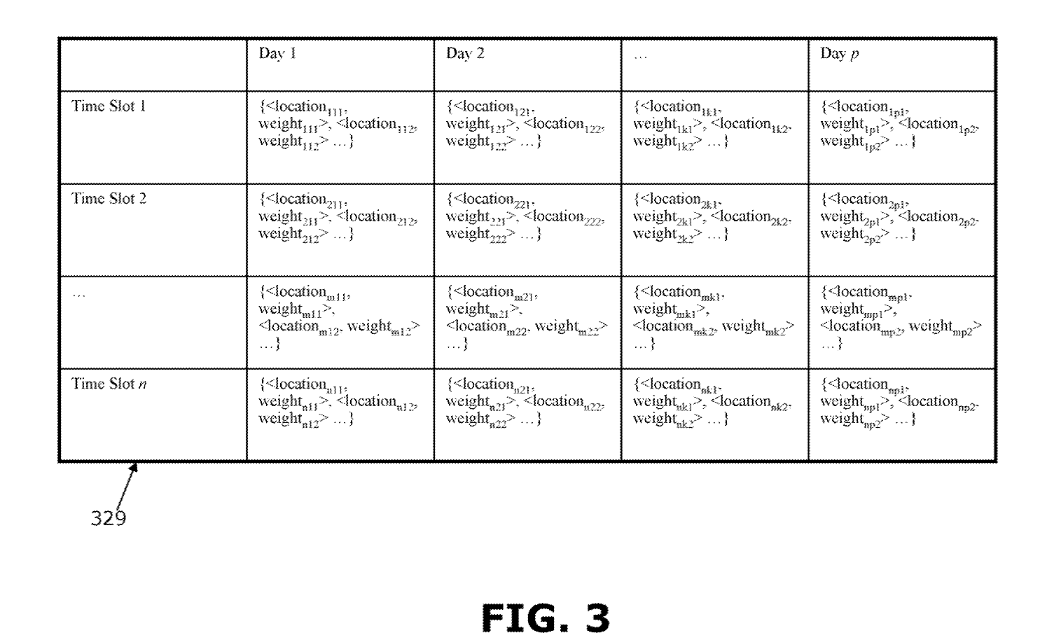

To facilitate easier reference, in advancing from FIG. 1 to and through FIG. 3, a reference numeral is advanced by a multiple of 100 in indicating a substantially similar or analogous component or element with respect to at least one component or element found in at least one earlier figure among FIGS. 1-3.

Broadly contemplated herein, in accordance with at least one embodiment of the invention, is a technique to determine the presence zones of a user or a group of users using telecom call data records (CDRs). No extra infrastructure is required, no data are required apart from the CDRs, and basic and smart phone users alike can be accommodated. Essentially, telecom CDRs are used for determining the presence region of a user or a group of users, this zone being defined both spatially and temporally. (Inasmuch as the term “presence” is employed variously herein, it should be appreciated and understood that the term can be considered to be interchangeable with the term “location”.)

More particularly, in accordance with at least one embodiment of the invention, telecom CDRs are used to determine user “presence regions”, as broadly defined and understood herein. Inasmuch as each CDR contains tower/cell ID and sector fields, the records can be used to track a user's movements over a period of time and determine the amount of time he spends at each location. Enriched contextual information can thereby be generated for subscribers, by associating the calling patterns of users with their locations.

In accordance with at least one embodiment of the invention, inasmuch as call records might be sparse or unavailable, user presence can still be determined. More particularly, it can be appreciated that CDRs might provide limited information in that a user might only make calls at certain times and in certain locations. (For instance, a user might well not make any phone calls from a particular location that lies on his/her work commute.) However, intelligent estimation techniques can be used to determine presence regions within a degree of probability. Conflicts can be resolved based on statistical averages, and available data can be interpolated or extrapolated to locations and times where CDRs are unavailable.

In accordance with at least one embodiment of the invention, presence information can be enriched by correlating it with social networks, and presence regions can be used as a platform for delivering promotions, ads, and notifications. Presence regions can be defined with respect to a single user or group of users. In the former instance, a data structure including a user's location (defined as a hierarchy, with lower confidence at lower levels) within a particular time period (also defined hierarchically) can be used. In the latter instance (e.g., in a social network), an overlap/intersection of the individuals' presence regions, along both location and time dimensions, can be employed. A telecom operator's CDRs can also be used and leveraged to determine a user's presence region.

FIG. 1 schematically illustrates a solution overview, in accordance with at least one embodiment of the invention. Users 101 place or receive calls, or send or receive texts (e.g., SMS messages) or data, through the medium of a telephone or wireless company, or telecom operator (telco) 103. An incoming or outgoing call, text or other data transmission is routed through a tower or other relay point 105, which itself provides information such as tower/cell ID and sector fields to a database or store of CDRs 107. CDRs in database 107 thereupon include a location and timestamp for the call, text or other data transmission, and such information is availed to a presence engine 109.

In accordance with at least one embodiment of the invention, the aforementioned information is transmitted to a presence finder 111 in presence engine 109. A presence table (113a/b/c) is formed for each subscriber, based on one or more CDRs (e.g., individual calls, texts, data transmissions, etc.), over a predetermined time period. Accordingly, for a given time period (or cycle duration) and granularity (or presence duration), weights are assigned based on the number of CDRs. Each presence table entry then becomes an ordered list of <user's location, weight> pairs. The spatial/temporal set of axes in FIG. 1 signifies that a presence zone incorporates both spatial as well as temporal dimensions of the movement of a user.

In accordance with at least one embodiment of the invention, a base presence table creator 115 assimilates readily available CDRs that are present in database 107. However, entries are also then deduced for which no corresponding CDRs exist via presence extrapolator 117. Accordingly, interpolation and/or extrapolation of such “missing” records takes places using the closest previous and next entries for which CDRs do exist. Once created, individual subscribers' presence tables 113a/b/c are merged, via pattern mining/merging 119, across different time periods. The output of this step is the ascertaining of consolidated presence zones 121, stored in a database or store 123.

In accordance with at least one embodiment of the invention, via a group presence finder 125 of presence engine 109, group presence zones are also formed. As such, a friends/group finder 127 can identify friends and contacts based on whom a user calls, with frequency and duration obtained from CDRs 107. With presence zones 121 from presence zone database 123 used as additional input, groups of friends with similar presence table entries can also be identified, whereupon social context can be deduced. For instance, such groups could involve friends that one interacts with in the morning, family members one interacts with in the evening, travel contacts, and other viable groups. In a manner to be explained more fully below, the output of this step is the ascertaining of group presence zones 131, stored in a database or store 133. Generally, group presence tables can be created once social networks have been created, and individual presence zones have been determined. Social networks can be created or determined via call graphs, e.g., ascertaining callers and quantitative aspects of how they call and interact with one another.

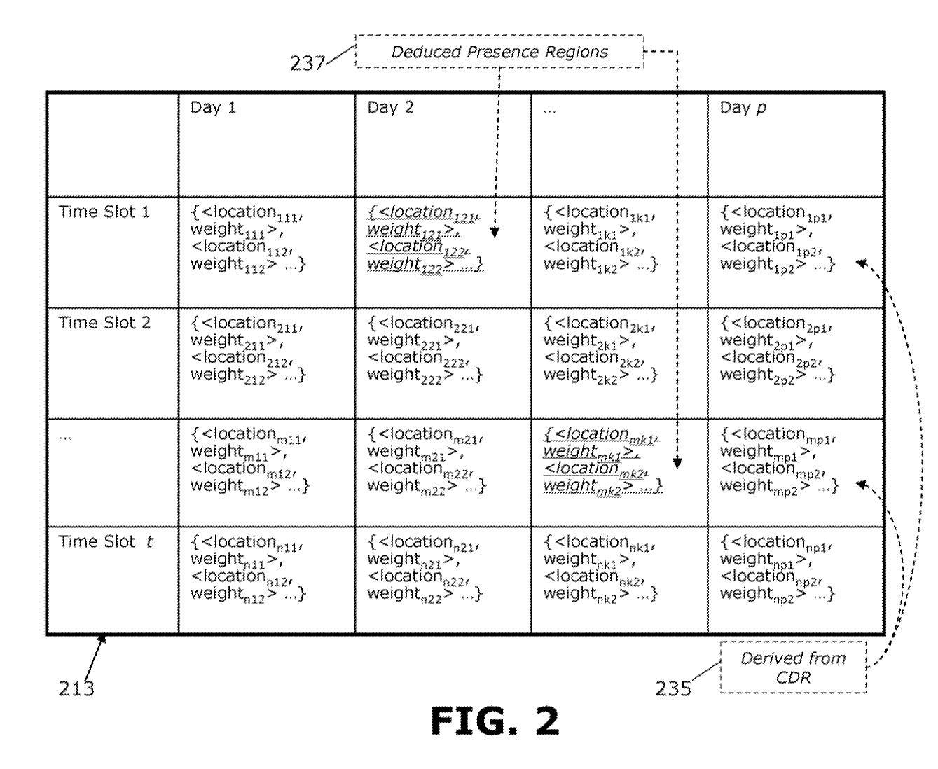

In accordance with at least one embodiment of the invention, FIG. 2 sets forth an example of a presence table 213. The table represents an array of days (1, 2, . . . p) and time slots (1, 2, . . . t) within each day. (By way of illustrative example, a time slot could correspond to one hour in a day, and may include one or more data pairs, <user's location, weight>, that each correspond to a CDR.) As shown, and as touched on herein, some entries (shown here in plain text) are entries that have been derived directly from CDRs (235), while others (237) have been deduced or extrapolated (shown here in italics and underline).

In accordance with at least one embodiment of the invention, for presence region deduction, missing table entries (237) can be computed by interpolation and extrapolation, using the available CDRs. Here, by way of an illustrative and non-restrictive example, there is considered the most frequently occurring location in each table entry. This may be the set of top n locations, or the minimum set of top locations whose weight sum exceeds x % (wherein n and x are scenario-dependent). By way of an example, if previous and next entries correspond to the same location then this indicates, with high probability, that the user was not moving. The missing entry will thus also be constructed to contain the same location, with a weight that is the minimum of weights of the two neighboring entries.

By way of another example, in accordance with at least one embodiment of the invention, previous and next entries correspond to different locations. Here, a user's trajectory can be identified on a map, e.g., via finding a shortest path between a previous and next location. The missing entry can then contain the mid-location along the trajectory, with a weight that is the product of the weights of the two neighboring entries.

By way of yet another example, in accordance with at least one embodiment of the invention, there may be n successive missing entries (n>1). If the entries before and after the missing range have the same location, that location can be assigned to all the missing entries, along with a weight equal to the minimum of the 2 weights. On the other hand, if the entries before and after the missing range have different locations, then n equidistant locations can be identified along the trajectory between the two locations. Here, the weight of each location can be the product of weights of the two end-point entries, divided by the number of points between that location and the closest end point.

Generally, in accordance with at least one embodiment of the invention, it can be appreciated that presence regions are meaningful mainly if they are deduced from representative data collected over a longer period of time. To this end, aggregation and statistical analysis can performed with respect to data collected over multiple cycles (e.g., time periods). For instance, with respect to CDRs collected over a longer time period such as 3 months, it can be determined that sufficient confidence is associated with a weekly presence regions table generated using techniques as broadly contemplated herein. Table entries can contain locations drawn from the entries in each cycle, and the weight of a location entry can be a normalized weight, using the total number of CDRs corresponding to that location and time slot.

In accordance with at least one embodiment of the invention, it can be generally appreciated that each entry in the location table is an ordered collection of locations. It can be seen that in a given class of applications, a single location or region provides more utility than a collection. As such, regions may be hard to pinpoint due to inherent fuzziness in data. More precisely, definable locations would be represented by those that are directly mapped from the cell tower and sector information in a CDR, while the weights of such locations may not be sufficiently high as to provide a definitive answer from long term-aggregated data.

Accordingly, in accordance with at least one embodiment of the invention, there are broadly contemplated herein mechanisms to determine a most accurate presence region by decreasing the location granularity. To this end, a weight and probability threshold are selected for the most frequently occurring location (e.g., 60%). If the weight of none of the locations (location₁₁₁, location₁₁₂, . . . location₁₁ₙ) exceeds 60%, there can then be determined the location of next-lower granularity using the following iteration:
Step 1: Add weights for location₁₁₂ to location₁₁₁; if it exceeds 60%, go to Step 2; else add the weight for location₁₁₃; . . . and so on. Collect these locations in a set L.
Step 2: Determine, from a map, the smallest location that contains all the locations in L. (Example: L={Vasant Kunj Sector C, Vasant Vihar, Hauz Khas}. Derived location=“South Delhi”.)
Then, leave the remaining locations with the existing weights (after aggregation and normalization).

FIG. 3 sets forth an example of a group presence table 329, in accordance with at least one embodiment of the invention (which, by way of an illustrative example, can have been created by the presence correlator 129 and stored in group presence zone database 133 as in FIG. 1). Here, there are found the most frequently occurring locations amongst members of a group. For each table entry, there are determined the locations in which the largest number of members of the group are present, which can be referred to as “mode”. A weight is assigned equal to the sum of weights for all members present in that location divided by the size of the group.

Embodiments of the present invention can embrace a wide variety of use cases. For example, third party service providers can send targeted promotional messages or advertisements to subsets of social groups based on their locations. In another example, event-specific information can be delivered based on a user's presence. In a further example, forensics can be employed in connection, e.g., with finding out individuals in the vicinity of a crime, based on presence zones.

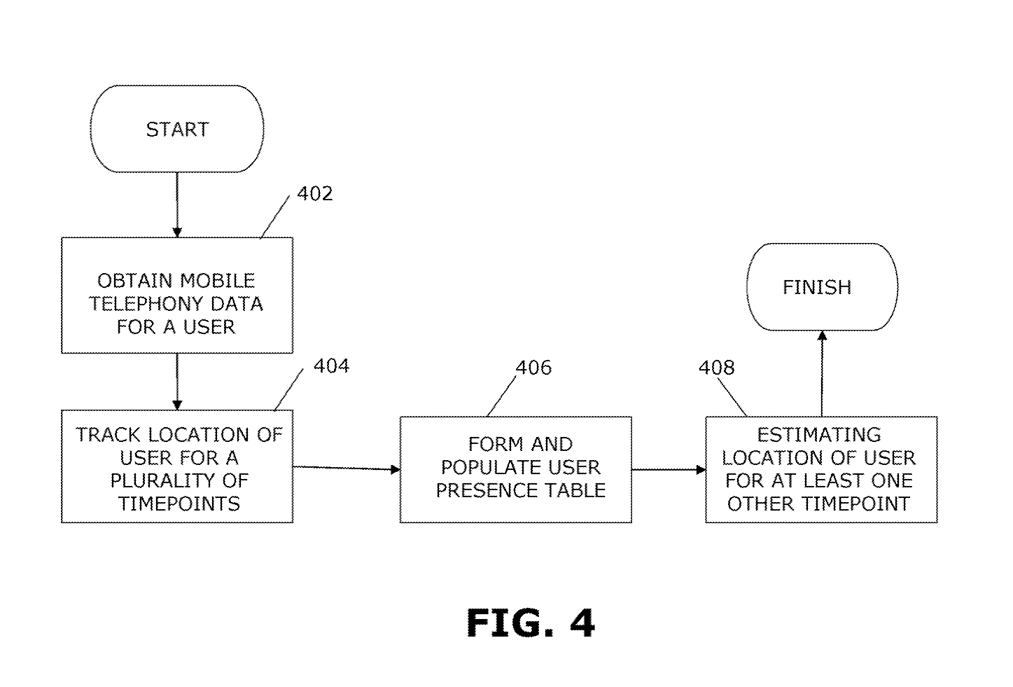

FIG. 4 sets forth a process more generally for ascertaining mobile presence regions, in accordance with at least one embodiment of the invention. It should be appreciated that a process such as that broadly illustrated in FIG. 4 can be carried out on essentially any suitable computer system or set of computer systems, which may, by way of an illustrative and non-restrictive example, include a system such as that indicated at 12′ in FIG. 5. In accordance with an example embodiment, most if not all of the process steps discussed with respect to FIG. 4 can be performed by way of a processing unit or units and system memory such as those indicated, respectively, at 16′ and 28′ in FIG. 5.

As shown in FIG. 4, in accordance with at least one embodiment of the invention, mobile telephony data are obtained for a user (402), and a location of the user is tracked for a plurality of timepoints (404). The tracking includes forming and populating a user presence table (406). With respect to incomplete information in the user presence table and based on data in the user presence table, a location of the user for at least one other timepoint is estimated (408).

Referring now to FIG. 5, a schematic of an example of a cloud computing node is shown. Cloud computing node 10′ is only one example of a suitable cloud computing node and is not intended to suggest any limitation as to the scope of use or functionality of embodiments of the invention described herein. Regardless, cloud computing node 10′ is capable of being implemented and/or performing any of the functionality set forth hereinabove. In accordance with embodiments of the invention, computing node 10′ may not necessarily even be part of a cloud network but instead could be part of another type of distributed or other network, or could represent a stand-alone node. For the purposes of discussion and illustration, however, node 10′ is variously referred to herein as a “cloud computing node”.

In cloud computing node 10′ there is a computer system/server 12′, which is operational with numerous other general purpose or special purpose computing system environments or configurations. Examples of well-known computing systems, environments, and/or configurations that may be suitable for use with computer system/server 12′ include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12′ may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12′ may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5, computer system/server 12′ in cloud computing node 10 is shown in the form of a general-purpose computing device. The components of computer system/server 12′ may include, but are not limited to, at least one processor or processing unit 16′, a system memory 28′, and a bus 18′ that couples various system components including system memory 28′ to processor 16′.

Bus 18′ represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12′ typically includes a variety of computer system readable media. Such media may be any available media that are accessible by computer system/server 12′, and includes both volatile and non-volatile media, removable and non-removable media.

System memory 28′ can include computer system readable media in the form of volatile memory, such as random access memory (RAM) 30′ and/or cache memory 32′. Computer system/server 12′ may further include other removable/non-removable, volatile/non-volatile computer system storage media. By way of example only, storage system 34′ can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18′ by at least one data media interface. As will be further depicted and described below, memory 28′ may include at least one program product having a set (e.g., at least one) of program modules that are configured to carry out the functions of embodiments of the invention.

Program/utility 40′, having a set (at least one) of program modules 42′, may be stored in memory 28′ (by way of example, and not limitation), as well as an operating system, at least one application program, other program modules, and program data. Each of the operating systems, at least one application program, other program modules, and program data or some combination thereof, may include an implementation of a networking environment. Program modules 42′ generally carry out the functions and/or methodologies of embodiments of the invention as described herein.

Computer system/server 12′ may also communicate with at least one external device 14′ such as a keyboard, a pointing device, a display 24′, etc.; at least one device that enables a user to interact with computer system/server 12; and/or any devices (e.g., network card, modem, etc.) that enable computer system/server 12′ to communicate with at least one other computing device. Such communication can occur via I/O interfaces 22′. Still yet, computer system/server 12′ can communicate with at least one network such as a local area network (LAN), a general wide area network (WAN), and/or a public network (e.g., the Internet) via network adapter 20′. As depicted, network adapter 20′ communicates with the other components of computer system/server 12′ via bus 18′. It should be understood that although not shown, other hardware and/or software components could be used in conjunction with computer system/server 12′. Examples include, but are not limited to: microcode, device drivers, redundant processing units, external disk drive arrays, RAID systems, tape drives, and data archival storage systems, etc.

It should be noted that aspects of the invention may be embodied as a system, method or computer program product. Accordingly, aspects of the invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the invention may take the form of a computer program product embodied in at least one computer readable medium having computer readable program code embodied thereon.

Any combination of one or more computer readable media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having at least one wire, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store, a program for use by, or in connection with, an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination of the foregoing.

Computer program code for carrying out operations for aspects of the invention may be written in any combination of at least one programming language, including an object oriented programming language such as Java®, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the invention are described herein with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture. Such an article of manufacture can include instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

What is claimed is:

1. A method comprising:
obtaining mobile telephony data for a user;
tracking a location of the user for a plurality of timepoints;
said tracking comprising forming and populating a user presence table; and
estimating, with respect to incomplete information in the user presence table and based on data in the user presence table, a location of the user for at least one other timepoint.

2. The method according to claim 1, wherein the data comprise call data records.

3. The method according to claim 1, wherein the data include at least one member selected from the group consisting of: location data; and timestamp data.

4. The method according to claim 1, wherein said tracking comprises capturing, discovering and imposing presence information at different levels of hierarchy on a geo-spatial map.

5. The method according to claim 1, wherein said tracking comprises ascertaining location information with respect to a group of people.

6. The method according to claim 5, wherein said ascertaining of location information with respect to a group of people comprises:
determining at least one overlapping location of the user with respect to at least one other person; and
storing, in the user presence table, information relating to the at least one overlapping location.

7. The method according to claim 1, wherein said estimating comprises extrapolating with respect to location data from at least one timepoint.

8. The method according to claim 1, wherein said estimating comprises interpolating with respect to location data from at least two timepoints.

9. The method according to claim 1, wherein said tracking comprises appending weights to location data in the user presence table.

10. An apparatus comprising:
at least one processor; and
a computer readable storage medium having computer readable program code embodied therewith and executable by the at least one processor, the computer readable program code comprising:
computer readable program code configured to obtain mobile telephony data for a user;
computer readable program code configured to track a location of the user for a plurality of timepoints, the tracking including forming and populating a user presence table; and
computer readable program code configured to estimate, with respect to incomplete information in the user presence table and based on data in the user presence table, a location of the user for at least one other timepoint.

11. A computer program product comprising:
a computer readable storage medium having computer readable program code embodied therewith, the computer readable program code comprising:
computer readable program code configured to obtain mobile telephony data for a user;
computer readable program code configured to track a location of the user for a plurality of timepoints, the tracking including forming and populating a user presence table; and
computer readable program code configured to estimate, with respect to incomplete information in the user presence table and based on data in the user presence table, a location of the user for at least one other timepoint.

12. The computer program product according to claim 11, wherein the data comprise call data records.

13. The computer program product according to claim 11, wherein the data include at least one member selected from the group consisting of: location data; and
timestamp data.

14. The computer program product according to claim 11, wherein said computer readable program code is configured to capture, discover and impose presence information at different levels of hierarchy on a geo-spatial map.

15. The computer program product according to claim 11, wherein said computer readable program code is configured to ascertain location information with respect to a group of people.

16. The computer program product according to claim 15, wherein said computer readable program code is configured to ascertain location information with respect to a group of people via:
determining at least one overlapping location of the user with respect to at least one other person; and
storing, in the user presence table, information relating to the at least one overlapping location.

17. The computer program product according to claim 11, wherein said computer readable program code is configured to estimate via extrapolating with respect to location data from at least one timepoint.

18. The computer program product according to claim 11, wherein said computer readable program code is configured to estimate via interpolating with respect to location data from at least two timepoints.

19. The computer program product according to claim 11, wherein said computer readable program code is configured to track via appending weights to location data in the user presence table.

20. A method comprising:
obtaining mobile telephony data for a user from call data records;
tracking locations of the user over a predetermined time period;
said tracking comprising forming and populating a user presence table; and
estimating, with respect to incomplete information in the user presence table and based on data in the user presence table, a location of the user with respect to at least one other time period.
